(19) United States
(12) Patent Application Publication
(10) Pub. No.: US 2024/0089339 A1
(43) Pub. Date: Mar. 14, 2024

(54) CACHING ACROSS MULTIPLE CLOUD ENVIRONMENTS

(71) Applicant: Salesforce, Inc., San Francisco, CA (US)

(72) Inventor: Kalyan Chakravarthy Thatikonda, San Francisco, CA (US)

(21) Appl. No.: 17/943,447

(22) Filed: Sep. 13, 2022

(51) Int. Cl. H04L 67/5681; G06F 9/50

(52) U.S. Cl. CPC H04L 67/5681; G06F 9/5055; G06F 2209/501

(57) ABSTRACT

Techniques and systems are provided for more efficient and reliable caching of responses that are based on API calls to a backend system. The disclosed embodiments use a containerized pipeline that can be linked to each application instance regardless of the specific cloud environment(s) on which the instance is hosted and executed. Instances of the application operating on different cloud environments can access the cached responses from the other environments, thereby reducing or eliminating latency that typically results from the deployment of caching and database solutions across different availability zones in one or more cloud environments.

### BACKGROUND

Application Programming Interfaces (APIs) are used to provide interfaces to software, services, or computer systems that can be used by other software applications. For example, a system or service that provides an API may allow access to various functions of the software or service for use by others, such as to retrieve data, execute available functions, or the like. Typically an API for a system or service receives a request having a standard format which is then parsed by the system or service to execute associated functions within the system or service and return an associated response, which may include various amounts of data available within the system or service.

### BRIEF DESCRIPTION OF THE DRAWINGS

FIG. 1A shows a schematic representation of a conventional arrangement where an application is deployed in multiple cloud environments.

FIG. 1B shows a schematic representation of an arrangement as disclosed herein, where an application is deployed in multiple cloud environments.

FIG. 2 shows an example system process flow for embodiments disclosed herein.

FIG. 3 shows an example process for providing cached API responses across multiple cloud environments according to embodiments disclosed herein.

FIG. 4 is an example computing device suitable for implementing aspects of embodiments disclosed herein.

### DETAILED DESCRIPTION

When used with cloud-based or other hosted services, APIs may use caching techniques to improve the performance of the API, especially where the API is likely to require frequent access to the same database object(s). Conventional API architectures may depend on various caching techniques to optimize the performance of the API transactions by retrieving frequently-accessed database objects from the caching systems; without such caching, the API would require significantly greater computing resources to implement with acceptable response times. However, conventional caching solutions are not well-suited for deployment in public clouds across different regions or zones to satisfy availability requirements. Deployment of the API across multiple regions or zones may improve availability, but often introduces latency issues when the application server that executes the API is required to access the cached objects from different regions or zones in a public cloud environment. Such issues may be particularly difficult to address when a single application is implemented across multiple cloud environments such as Amazon Web Services (AWS)®, Google Cloud Services®, Microsoft Azure® cloud systems, and the like. Deployment of applications across multiple cloud environments is becoming more common to improve resiliency, scalability, and the like. However, because conventional caching techniques are environment-specific, an application deployed across multiple cloud environments cannot access cache results from one environment to another. In a conventional system, this requires developers to use the native caching systems of each cloud environment for the instance of the application running on that particular environment, which leads to duplicative development and reduced efficiency.

Further, conventional cloud-based caching systems typically focus on techniques to retrieve data from the cloud system cache as quickly as possible and on the durability and availability of the caching services themselves. As a result, existing cache systems do not provide transaction records for applications that are deployed across multiple cloud environments and lack the capabilities to record cache and database transactions occurring on different cloud environments.

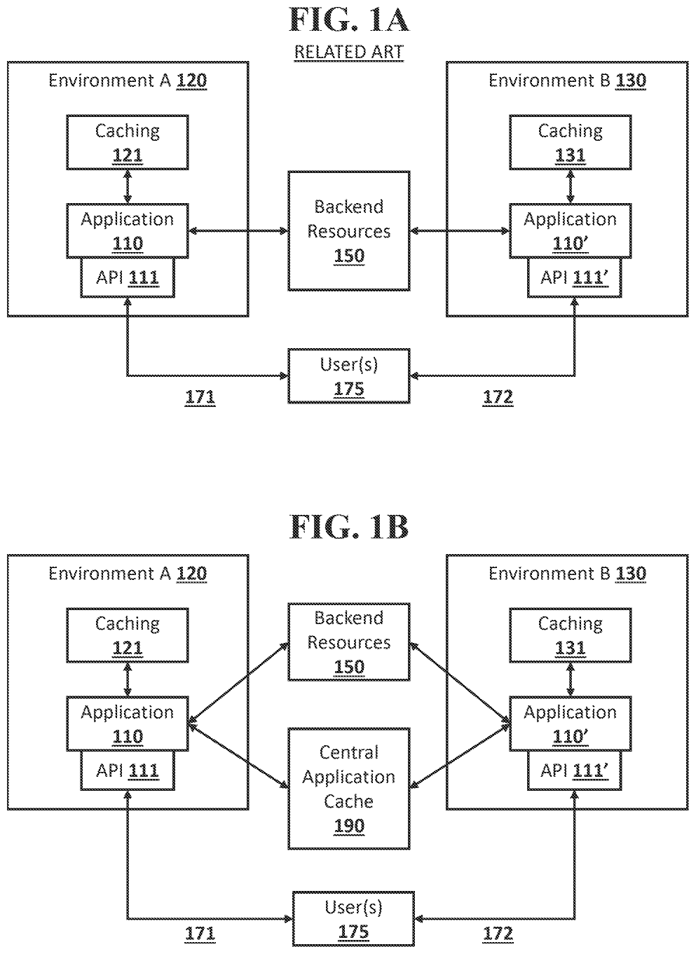

For example, a single application may be deployed in multiple cloud environments, such as to improve user access, scalability, response time and latency, and various other reasons. FIG. 1A shows a schematic representation of a conventional arrangement where an application is deployed in multiple cloud environments. The application may include different instances 110, 110′ of the same application that are deployed in two different cloud environments 120, 130. Each instance typically is a native version of the application that has been developed for that particular cloud environment, though in some cases they may use common backend resources 150, such as where each instance provides an interface to the same database or other resource.

One or more users 175 may access the application via requests 171, 172 sent to the application API 111, 111′. The specific cloud environment 120, 130 to which a particular request is routed may be determined by geographic or logical proximity, content delivery network rules, routing rules, or the like. For example, the application may be designed so that users in different geographic areas or different segments of the internet are routed to different cloud environments 120, 130, and thus interact with the associated instances 110, 110′ of the application. When a first request 171 is received by the application 110 via its API 111, it is processed by the application instance 110. The request may, for example, result in a database transaction that is executed on the associated cloud environment A 120. The transaction can be cached as a cache object in the cache 121 of the cloud environment 120.

Similarly, a request 172 routed to cloud environment B 130 will be executed via the application instance 110′ via its API 111′. However, because cloud environment B 130 cannot access the cache 121 of cloud environment A 120, even if the second request 172 could be resolved with the same response as the first request 171, the previously-stored cache object cannot be used to process the request 172 and the transaction will be executed by the application 110′, which likely results in redundant and unnecessary communications with the backend resources 150. That is, for an identical or similar transaction 172 in cloud environment B 130, a redundant transaction is processed where if the same request was received by cloud environment A 120, it could be resolved via a cached response. This can be expensive both in terms of API and application performance, as well as response time and network congestion effects of the application 110/110′.

Embodiments disclosed herein provide solutions to these and other issues related to caching across multiple cloud environments by using a container that can be linked to each application instance regardless of the specific cloud environment(s) on which the instance is hosted and executed. This improves the performance of API transactions by reducing or eliminating the latency that typically results from the deployment of caching and database solutions across different availability zones in one or more cloud environments and may also reduce the congestion of network traffic for applications that interact with stateful services through APIs.

FIG. 1B shows a similar system according to embodiments disclosed herein. In this case, each application instance 110, 110′ has access to a central application cache 190 as described in further detail herein. The central application cache and associated components and processes allows each application instance to access cached data from prior requests regardless of the cloud environment from which the prior requests originated. Continuing the example above, if a request 171 routed to, and processed by, the application instance 110 hosted on cloud environment A 120, the response data may be cached in the central application cache 190 using techniques disclosed herein. If the subsequent request 172 can then be answered by the cached request/response, the application instance 110′ hosted on cloud environment B 130 can use the cached data from the central application cache to process the request 172, as if the response was available in the native cache 131 for the cloud environment B 130. Accordingly, embodiments disclosed and claimed herein may provide for decreased response latency, processing overhead, and network congestion due to the elimination of redundant processing that would otherwise be required by a conventional system as shown in FIG. 1A.

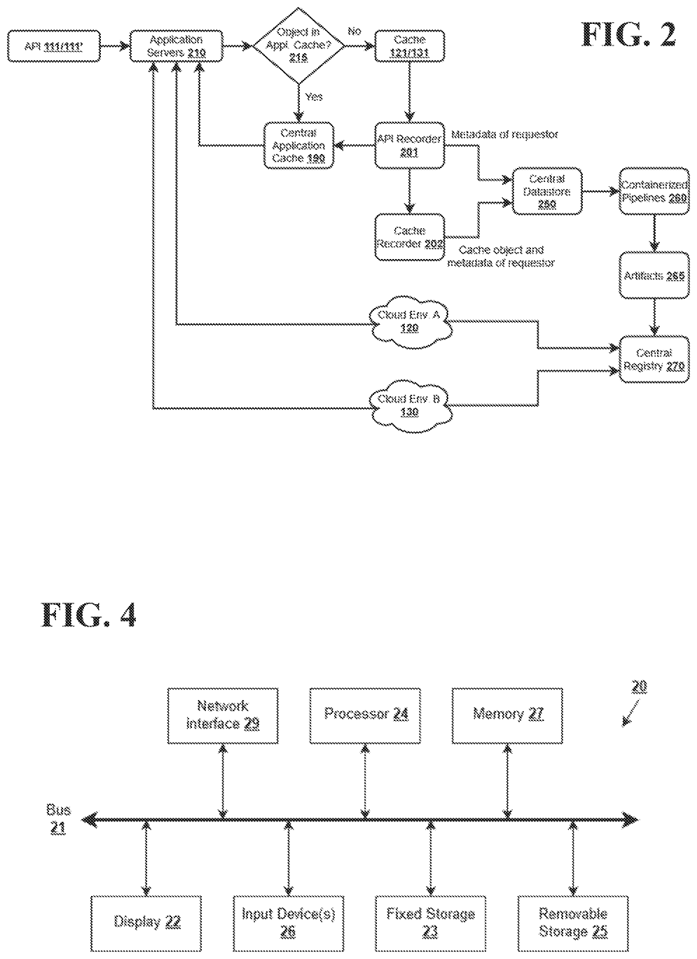

To implement a central application cache 190, applications that operate according to embodiments disclosed herein may record each API transaction that interacts with a stateful backend service such as a cache and database. FIG. 2 shows an example system process flow for embodiments disclosed herein. As previously disclosed, an application API 111/111′ receives requests to execute various functionality of an application, which may be hosted on one or more cloud environments. Application instances may be executed on one or more application servers 210 or any equivalent cloud-based hardware system. When a request such as request 171/172 in FIG. 1B is received by the application, the application may determine at 215 whether an object sufficient to answer the request exists in a central application cache 190. If no such object exists, the application may execute the request in the usual course, for example as it would if it was the only instance of the application hosted on a single cloud service. The response may then be cached in a native cache 121/131 of the associated cloud environment as it would during regular operation of the application in conjunction with a conventional application cache.

When an API request is received by an application as disclosed herein, the API recorder 201 may capture metadata associated with the request that is unique to the requestor and may store it, for example, in a key/value central datastore. The metadata may include, for example, the request type, requestor identity, location, and/or cloud environment hosting the application instance. It may be preferred for the metadata to be sufficient to uniquely identify the request. This allows subsequent requests to be matched with previous identical requests, thereby allowing the cached object of the request/response to be used to process the later (identical) request. In some cases an “identical” request may be functionally identical and may include trivial differences. For example, two requests that access the same API call(s) using the same parameter(s) but have extraneous information not relevant to the request may be considered “identical” as used herein. The metadata also may include information about the requestor, such as where the backend services being accessed operate differently for different users. In this case, it may be required that identical requests also have matching requestor metadata, since a cached response for one requestor may be different for other requestors. In other systems or for other API calls, the requestor identity may be irrelevant to the API request/response and the requestor metadata may not be necessary to uniquely identify a request or identify an identical subsequent request.

API requests that retrieve data from cache objects may be monitored by a cache recorder 202, which may store the cache data, for example by appending requestor metadata received from the API recorder 201. Thus, for every API transaction, a dataset is created based on the requestor-specific metadata and the data accessed from cache objects which then may be stored in a central datastore 250.

The API transactions recorded by the API recorder 201 and/or the cache recorder 202 may be made available across multiple clouds are by a secure containerized pipeline 260 that generates artifacts 265 for those transactions. In some embodiments, the artifacts 265 may be containerized applications executed by the application servers 210, such as Docker style containers as defined by Docker, Inc. The containerized pipeline 260 operates outside the conventional API calls and thus does not cause an increase in the type or number of responses processed by the API. Pipeline triggers that are setup as part of secure containerized pipelines track updates in the centralized datastore 250 and generate the latest artifacts 265 based on changes added to the centralized datastore 250. There is no additional burden to the API because the linked containers are updated dynamically based on the latest updates from the centralized datastore 250. Conceptually, this process may be considered as similar to the process for a continuous deployment model in which the pipeline triggers wait for changes introduced and generate artifacts accordingly.

More generally, the artifacts 265 and/or the central registry 270 may be implemented as any suitable standardized data storage format that can be integrated with the application(s) executing on one or more application servers 210. The standardized format generally will not be a native cache of the cloud environments 120/130 on which the application is hosted, since it should be agnostic to any particular cloud environment. As used herein, a “container” refers to a logical structure for operating within a containerized pipeline and providing a standardized data format as described above, of which Docker containers are one example.

The transactions themselves may be stored in a central registry 270 dedicated to the various cloud environments. The central registry 270 may be stored in any cloud environment 120, 130 and exposed to the other environments, for example via a separate API that is accessible to the application instances hosted on those environments. The centralized registry may be, for example, a Docker registry, which stores the Docker images as described and/or any other data associated with the cached API transactions. Generated artifacts 265 are thus made available to multiple cloud environments 120, 130 via a container that is linked to each instance of the application regardless of which cloud environment 120/130 is hosting the application instance.

Containers storing the transactions and artifacts may be linked to the application servers 210, from where they may discover each other and securely transfer information about one container to another container. The application servers 210 thus are able to access API transactions that occurred across multiple cloud environments based on the metadata available associated with those transactions, regardless of which cloud environment 120/130 in which those transactions originated. Each application or application server 210 may be linked to a Docker container in the Docker registry 270 as previously disclosed, which may be updated as needed when a cached response is stale or otherwise requires a different response than the original response represented by the container. This update may be performed, for example, using the containerized pipeline 260 as previously disclosed.

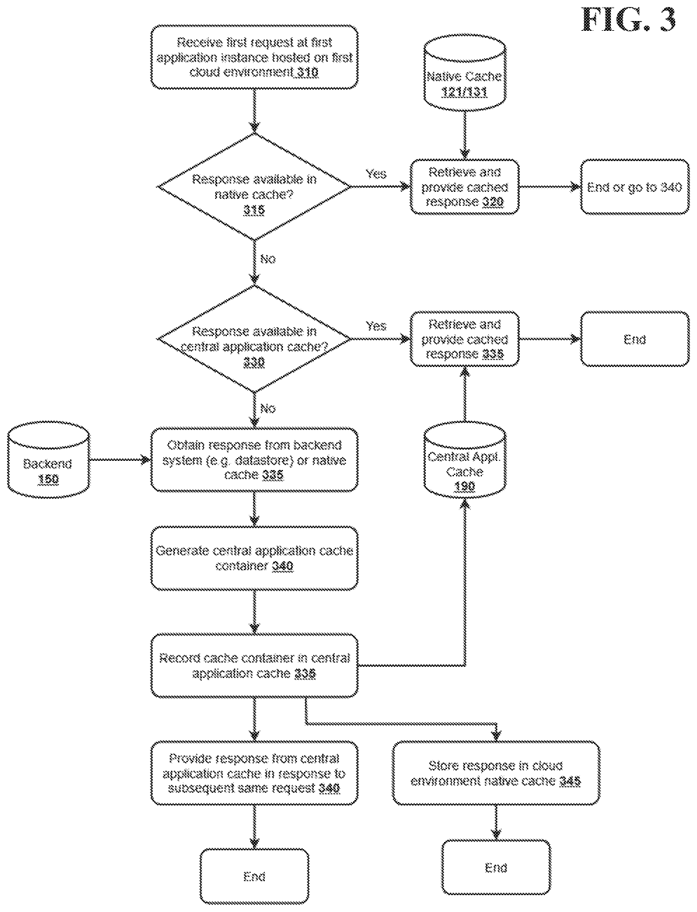

FIG. 3 shows an example process for providing cached API responses across multiple cloud environments according to embodiments disclosed herein. At 310, a request is received by an instance of the application hosted at a first cloud environment, such as cloud environment A 120 as previously described. As used herein, a “request” or “API request” refers to any suitable call to an API as defined by an application deployed across multiple cloud environments, typically via an API that is exposed by the application itself, but which may include attributes, functions, calls, or other components of the hosting cloud environment. Typically a request will return data and/or an indication of successful completion that ultimately is provided to a user, client application or device, or other entity that initiated the API request, though such entity may not be an end user and may instead be an intervening interface or application.

At 315, the system determines if a response to the API request is available in the hosting cloud environment's native cache. In this case the response may be retrieved from the native cache 121/131 at 320 and provided in response to the request in the usual manner.

If no response is available in the native cache 121/131, at 330 the system may then query a central application cache to determine if a suitable response is available, for example as described with respect to FIG. 2. If a suitable cached response is available, it may be retrieved and provided at 335 as previously described. Notably, the recipient of the response need not be aware of, or able to determine, whether the response returned by the application was retrieved from a native cache 121/131, a central application cache 190, or retrieved from a backend system 150, though in many embodiments one or both types of cached responses may provide a faster response than retrieval from the backend system 150.

Although FIG. 3 shows the native cache 121/131 being queried before the central application cache 190, in some embodiments the central application cache 190 may be queried first or concurrently with the native cache 121/131.

If no cached response is available, a response may be retrieved from the backend system 150 at 335 as would be done in a conventional system in the absence of a suitable cached response.

Once a response is obtained and provided in response to the API request, the request/response may be considered complete and the system may end the process. However, if no cached response was found, or if no cached response was found in the central application cache 190, or if the central application cache was not queried, at 340 the system may generate a cached response or cache container as previously disclosed. If a response was retrieved from a native cache at 320, the system may first query the central application cache 190 to determine if no equivalent cached response is available in the central application cache 190 or if there is a stale cached response that should be replaced by the response obtained from the native cache 121/131 or the backend 150.

At 335, the system may record the cache container containing the response in the central application cache as previously described with respect to FIG. 2. This response then may be provided to subsequent API requests at 340.

The response also may be stored in the usual manner in a native application cache 121/131, for example where the response was obtained from the backend 150 at 335 or from the central application cache at 335 (where no prior native cached response exists).

Although described with respect to API transactions, the architecture, systems, and processes disclosed herein may also be applied to long-running database queries that require a large amount of computing resources to execute. Such queries may include, for example, dynamic queries, queries that request large amounts of historical data, or the like. This may allow for such transactions to be served directly from the application layer cache without needing to execute the complete queries on a backend database, thereby saving significant time and providing much faster responses to queries that normally would be expected to take a much longer time and correspondingly larger computing resources to execute.

Similarly, embodiments provided herein may increase the performance and network transactions of similar or identical API since application servers need not look for cached information from caching systems but may serve the API transactions within the application servers themselves, thereby reducing network congestion. For example, as disclosed herein, responses cached in a central application cache as described may be stored in Docker containers that integrate the application, or portions of the application, and the cached response(s), and/or in Docker containers that are included in a Docker registry that is directly accessible by the application(s). Accordingly, the response is available to the application without the need for expensive back-and-forth communication with a separate cache system. Similarly, API transaction performance may be improved by reducing or eliminating latency for frequently-accessed cache objects which can be fetched from the central application cache as opposed to querying the data from a separate caching layer. This also may prevent the need to cross security groups and zones to access data for cache objects, thereby further reducing the latency typically associated with such requests. Because every transaction in a public-facing cloud environment has an associated computational and thus monetary cost both to the hosting cloud environment as well as the customer that manages the hosted application, the systems and techniques disclosed herein also may reduce computational and monetary cost by avoiding unwanted network requests for API transactions, long-running database queries, and the like.

Embodiments disclosed herein provide improvements, updates, and/or additions to conventional cloud-based systems that use API and/or other system calls and interfaces as disclosed herein. Such improvements may include reduced latency as previously disclosed, reduced use of computing resources such as processor time and cycles, storage requirements, and the like, and may be achieved through use of any combination of features as recited in the claims presented herein.

Embodiments disclosed herein may be implemented in and used with a variety of component and network architectures. FIG. 4 is an example computing device 20 suitable for implementing aspects of embodiments disclosed herein, including but not limited to a server or cloud computing component suitable for hosting and/or implementing an application as disclosed herein, a device accessing a backend system such as via one or more APIs as disclosed herein, a backend system accessed by one or more cloud-based applications, or the like. The device 20 may be, for example, a desktop or laptop computer, a mobile computing device such as a phone or tablet, or the like, a rack-based and/or headless server or other server architecture, or the like.

The device 20 may include a bus 21 which interconnects major components of the computer 20, such as a central processor 24, a memory 27 such as Random Access Memory (RAM) or the like, a user display or other output device 22 such as a display screen, one or more user input devices 26, which may include one or more controllers and associated user input devices such as a keyboard, mouse, touch screen, and the like, a fixed storage 23 such as a hard drive, flash storage, and the like, a removable storage unit 25 operative to control and receive an optical disk, flash drive, and the like, and a network interface 29 operable to communicate with one or more remote devices via a suitable network connection.

The bus 21 allows data communication between the central processor 24 and one or more memory components. Applications resident with the computer 20 are generally stored on and accessed via a computer readable medium, such as a fixed storage 23 and/or a removable storage 25 such as an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, Wi-Fi, Bluetooth®, near-field, and the like. For example, the network interface 29 may allow the computer to communicate with other computers via one or more local, wide-area, or other communication networks. Other components may be included and some described components may be omitted without departing from the scope or content of the disclosed embodiments. For example, in embodiments in which the disclosed systems and methods are embodied in a server farm or rack system or similar, the system may include various system-level cooling components, communication interfaces, or the like.

More generally, various embodiments may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general-purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A method comprising:
receiving a first request at an instance of an application hosted on a first cloud environment;
obtaining a first response to the first request from a datastore;
determining that the first request is not available in a central application cache accessible by the application;
responsive to determining that the first request is not available in the central application cache, generating a cache record comprising the first request, the first response, and metadata that is sufficient to uniquely identify the first request;
storing the cache record in a container of the central application cache;
receiving a second request by the instance of the application hosted on the second cloud environment;
determining that the second request is a duplicate of the first request based on the metadata; and
responsive to the second request, providing the first response from the cache record.

2. The method of claim 1, further comprising:
prior to obtaining the first response, determining that the first response is not available in a native cache of the first cloud environment.

3. The method of claim 2, wherein generating the cache record is further performed in response to determining that the first response is not available in the native cache.

4. The method of claim 1, wherein the central application cache includes cache records generated in response to prior requests, and wherein the application cache is a standardized data storage format that is not a native cache of the first cloud environment or the second cloud environment.

5. The method of claim 1, further comprising:
receiving a third request by the instance of the application hosted on the first cloud environment;
determining that the third request is the same as a prior request for which a response is available in the central application cache; and
providing the response available in the central application cache in response to the third request.

6. The method of claim 5, wherein the prior request is received by an instance of the application hosted on a cloud environment different from the first cloud environment.

7. The method of claim 1, further comprising:
linking the container to the instance of the application hosted on the first cloud environment; and
linking the container to the instance of the application hosted on the second cloud environment.

8. The method of claim 1, further comprising:
receiving a third request at the instance of the application hosted on the first cloud environment;
determining that a response to the third request is available in a native cache of the first cloud environment; and
providing the response to the third request from the native cache in response to the third request.

9. The method of claim 8, further comprising:
generating a second cache record comprising the third request, the response to the third request, and metadata that is sufficient to uniquely identify the third request; and
storing the second cache result in a container of the central application cache.

10. A cloud computing system comprising:
a computer processor executing a cloud-based instance of an application in a first cloud environment, the application being configured to:
receive a first request;
obtain a first response to the first request from a datastore;
determine that the first request is not available in a central application cache accessible by the application;
responsive to determining that the first request is not available in the central application cache, generate a cache record comprising the first request, the first response, and metadata that is sufficient to uniquely identify the first request; and
store the cache record in a container of the central application cache;
a computer processor executing a cloud-based instance of the application in a second cloud environment different from the first cloud environment, the application being further configured to:
receive a second request;
determine that the second request is a duplicate of the first request based on the metadata; and
responsive to the second request, provide the first response from the cache record.

11. The system of claim 10, the application being further configured to:
prior to obtaining the first response, determine that the first response is not available in a native cache of the first cloud environment.

12. The system of claim 11, wherein generating the cache record is further performed in response to determining that the first response is not available in the native cache.

13. The system of claim 10, wherein the central application cache includes cache records generated in response to prior requests, and wherein the application cache is a standardized data storage format that is not a native cache of the first cloud environment or the second cloud environment.

14. The system of claim 10, the application further being configured to:
receive a third request by the instance of the application hosted on the first cloud environment;
determine that the third request is the same as a prior request for which a response is available in the central application cache; and
provide the response available in the central application cache in response to the third request.

15. The system of claim 14, wherein the prior request is received by an instance of the application hosted on a cloud environment different from the first cloud environment.

16. The system of claim 10, wherein the system is configured to:
link the container to the instance of the application hosted on the first cloud environment; and
link the container to the instance of the application hosted on the second cloud environment.

17. The system of claim 10, the application further being configured to:
receive a third request at the instance of the application hosted on the first cloud environment;
determine that a response to the third request is available in a native cache of the first cloud environment; and
provide the response to the third request from the native cache in response to the third request.

18. The system of claim 17, wherein the system is further configured to:
generate a second cache record comprising the third request, the response to the third request, and metadata that is sufficient to uniquely identify the third request; and
store the second cache result in a container of the central application cache.
